(19) United States
(12) Patent Application Publication
(10) Pub. No.: US 2008/0154716 A1
(43) Pub. Date: Jun. 26, 2008

(54) Consolidated digital direct advertising and advertisement distribution

(76) Inventor: David Meazoa, Miami, FL (US)

Correspondence Address: STEVEN PINKERT , ESQ, PINKERT LAW FIRM ,P.A ONE DATRAN CENTER - STE 1702, 9100 S. DADELAND BLVD, MIAMI, FL, 33156, US

(21) Appl. No.: 11/643,620

(22) Filed: Dec. 21, 2006

(51) Int. Cl. G06Q 30/00

(52) U.S. Cl. 705/14

(57) ABSTRACT

A computer-based method and interactive system for consolidated marketing of vendors and advertising distribution over a network or interactive television that provides for consumer registration with selected advertisers (vendors) thereby enabling both updated advertiser (vendor) information for the consumer and tracking of consumer interests by the advertisers (vendors). In addition, the computer-based method and interactive system contains an accounting program which will monitor the charges to each vendor based on the popularity and size requirements of their provided advertising information, and remove any advertisers who are no longer participating in the computer-based advertising service. A method by which advertisers (vendors) may target consumers specifically interested in their products, based on preference and demographic information collected by the computer-based method and interactive system.

### FIELD OF THE INVENTION

This present invention relates generally to the field of direct advertising by computer, interactive advertising systems by network or television, and Customer Relation Management (CRM) Systems.

### BACKGROUND OF THE INVENTION

The invention provides a much needed improvement in the area of digital and television advertising and an improvement in CRM systems. More specifically, the invention comprises a method via an interactive local computer system or interactive television and central database that consolidates advertising of multiple vendors (advertisers) in one system providing consumers the ability to select advertisers or products and register over a network to receive additional information regarding those advertisers or products. Advertisers (vendors) that have been selected provide updated information for the consumer and track consumer interest. The system integrates with Customer Relations Management (CRM) systems. Consumer contact information and data including product preferences, interests, etc., provide data for the advertiser's CRM system.

The system also provides a new business method for digital direct advertising. In one embodiment this method involves charging advertisers for the distribution of the software. Since the cost of the distribution of the software is divided among all of the participating advertisers it provides a relatively inexpensive means of advertising. In the interactive TV embodiment, the cost of the production and television distribution is divided among the participating advertisers. Overhead and profit are added to the distribution cost in the model. Overhead will include system software and hardware (primarily server) maintenance, and Research and Development. Use of the system including updates to products (and services) of the advertiser will continue for either a specific period of time based on the charge for the distribution or will terminate at the time of subsequent distributions. Extensions of time are available, as are new distributions, although new distributions need not necessarily be on CD but may occur vis a vis an update over a network.

### SUMMARY OF THE INVENTION

Before the subject invention is described further, it is to be understood that the invention is not limited to the particular embodiments of the invention described below, as variations of the particular embodiments may be made and still fall within the scope. It is also to be understood that the terminology employed is for the purpose of describing particular embodiments, and is not intended to be limiting.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs. Use of the pronoun “he” should be understood to refer to he or she, and “him” should be understood to refer to him or her.

The details of one or more embodiments of the invention are set forth in the accompanying drawings and the description below. Other features, objects, and advantages of the invention will be apparent from the description and drawings.

In view of the limitations now present in the prior art, the present invention provides a new and useful method and interactive computer system for consumer selection of specific vendor/advertisers from a list of vendor/advertisers.

The system provides for consumer registration with chosen vendor/advertisers vis a vis the local software program and over a network and into a central database, or alternatively interactive television and into a central database. The consumer does not register with the vendor directly. Subsequent to registration, consumers receive updated advertising and information from the selected vendor/advertisers and vendor/advertisers can track consumer interest in their products. The consolidated vendors and their information is presented in an easy to use Graphic User Interface (GUI).

In addition to providing data for an advertiser to track consumer's interest in their brand, other brands, or products, the database also provides data for the vendor's CRM system including but not limited to, contact records and consumer interest data. This data will help to establish new marketing channels for CRM platforms.

The present invention is distributed to consumers via network, CD, other data storage medium, or via interactive television. The system utilizes a GUI (graphic user interface) that displays advertisers and their products interactively to the consumer. Databases, found on the local system of the consumer's computer or a remote central database, contain the advertiser's content, user's preferences and demographic information, and accounting functions which monitor the charges accrued to each advertiser. The local database resides in the consumer's system (unless the system is accessed via interactive television) and information is sent and received from the central database that can be located anywhere with access to a network or telephone modem connection.

### BRIEF DESCRIPTION OF THE DRAWINGS

FIG. 1 is a flow chart showing the installation process of the preferred embodiment of the present invention.

FIG. 2 is a flow chart of the operative process of the preferred embodiment of the present invention.

FIG. 3 is a block diagram of the distribution and advertising method of the present invention.

### BRIEF DESCRIPTON OF PERSONAL COMPUTER PREFERRED EMBODIMENT

Upon installation of the system into the consumer's personal computer via CD or other downloadable media, the consumer is provided multiple vendor/advertisers with customized information from each of the participating vendors. This information can variously contain graphics, text, links to websites, product advertisements, animation, and videos contained in navigable screens and sub-screens. The consumer selects the advertiser (vendor) or products he is interested in and registers those preferences in the central database. Subsequently he is able to obtain updates for his chosen advertisers and products and thereby provide tracking information of his interests for the selected advertisers. Also, this selection of advertisers or their products, and the consumer's registration forms a database with that can provides contact information and preference information for the CRM systems of advertisers. All this is accomplished quickly through various screens that the consumer can navigate through using a mouse or other computer input device. The consolidation and registration of various vendors in a seamless program with network connection result in a new direct marketing system that is not apparent, obvious, or suggested, either directly or indirectly by any of the prior art apparatus.

The program in the personal computer embodiment is generally distributed by CD, downloaded or transferred to the consumer's computer by other digital media. The CD may be distributed by direct mail, direct marketing or any other chosen method. Upon installation the graphical interface appears.

It can be appreciated that in this preferred embodiment the various advertisers are presented on a spinning figure that the user can control. On the face or facet of the rotating figure are the logos of various consolidated advertisers that wish to avail themselves of this direct advertising method. The figure spins at user controlled speeds and can slow, stop or reverse depending on cursor movement via mouse or other input device over the figure. The frequency of presentation of a specific logo (or advertiser) is also adjustable as frequency of appearance on the figure determines the amount of exposure that an advertiser receives and relates to the cost of advertising in this system.

One skilled in the arts will appreciate that a variety of geometric figures could be utilized with finite or virtually infinite surfaces. The spinning figure can present an infinite number of advertisers and not repeat for many revolutions, or it might repeat the logos (advertisers) every ½ revolution for example. For example a pyramid shape could rotate along its vertical axis and present 3 items (logos) one on each face or more—virtually.

Sound is also optionally provided and may be uniquely associated with each item. For example a jingle that is associated with a specific brand (advertiser) will play when the item appears on the spinning figure or when it is selected with a mouse or other input device.

The logos for the figure and associated background sounds are originally supplied on the distribution CD or downloaded software. However, when the consumer updates his software he will receive new logos and associated advertisements and sounds that are downloaded from the central database. All new advertising logos or modified logos will be downloaded to the consumer at each update. As explained below the consumer can customize the figure and decide which categories and advertisers to display.

Selecting a logo causes a new screen to display with more information about the advertiser. This screen could, depending upon the advertiser's choice, contain special offers, sales, coupons, a video, navigation buttons to other screens, a “www” link is also provided to the advertiser's related web pages which might include online shopping, etc. A button for updates only from a specific advertiser is also provided.

The initial information on this screen resides in the “local database” that was installed in the consumer's computer at the time he installed the software. When the user selects “update” new information is updated to the “local database” from the central database server. This updated information was provided to the central database server from the advertiser's data or database. The system has the ability to automatically update the central server database from the advertiser's database. Updated data in the users “local database” may contain new or updated product information, specials, links, sounds, graphics, text, animations, videos, basically any information that can be transmitted via digital means.

### Interaction of the Advertiser, Consumer, and Database System

The invention involves a central database system, consumers that have installed the software program and advertisers. Advertisers choose to affiliate with the system and supply information about themselves or their products that are distributed with a release of the software or provided to the central database. The central database provides updates to the consumers' local personal computers when the consumer performs an update.

### Detailed Description of the Preferred Embodiment

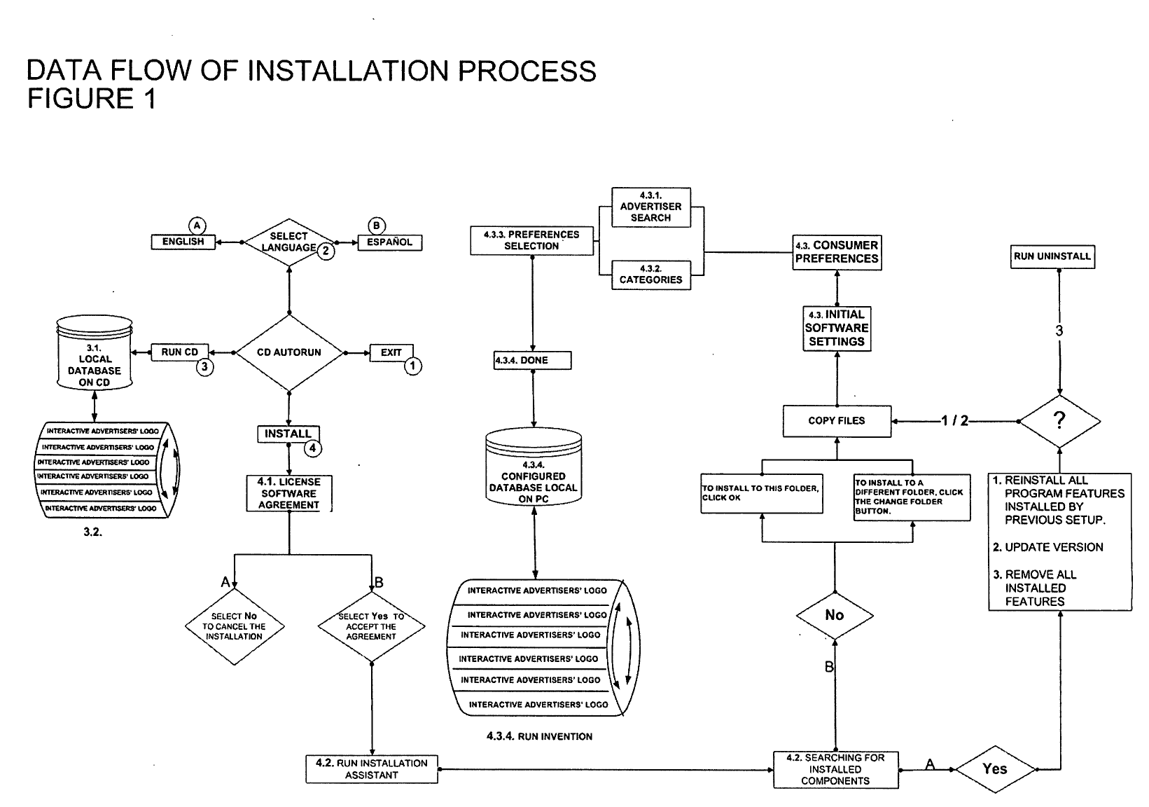

Referring now descriptively to the drawings, the attached figures illustrate a Consolidated Digital Direct Advertising and Advertisement Distribution System. Referring to FIG. 1 which illustrates the data flow during the installation process of the preferred embodiment of the invention. Reference is made to logic, display screens and database organization to enable one skilled in the art to understand, create, and use the invention.

The software is preferably distributed on a CD, but may be distributed by other digital media, downloaded over a network or by other means. The software distribution contains software that comprises a Graphical User Interface (GUI), database access, program logic, a preconfigured (local) database of participating advertisers 3.1 and an internal user preference table of Software Settings 4.3.

The preconfigured (local) 3.1 consists of database entries for each participating advertiser and the data and information that each of the advertisers want to make initially available with the mass distribution. This includes advertiser identification for internal purposes and may variously include logos, other graphics, backgrounds, sounds, music, text, links, animated clips, and videos that are displayed in association with the advertiser. This local database that is preconfigured at the time of installation can be modified by updating, which is described in detail below.

The software also contains an internal user preference table, Software Settings 4.3. Consumer Preferences 4.3 contains Initial Software Settings 4.3 upon installation, but has the ability to be customized to those settings that the user specifies. These default settings provide for display of all advertisers included in the distribution without respect to their product lines or categories (e.g., grocery stores, home improvement, department stores, and medical services). Initial Software Settings 4.3 also contains default settings for language, background themes, sound and other display settings. Initial Software Settings 4.3, like all other user configurable data, is accessed through the GUI and interactive screens as further described below.

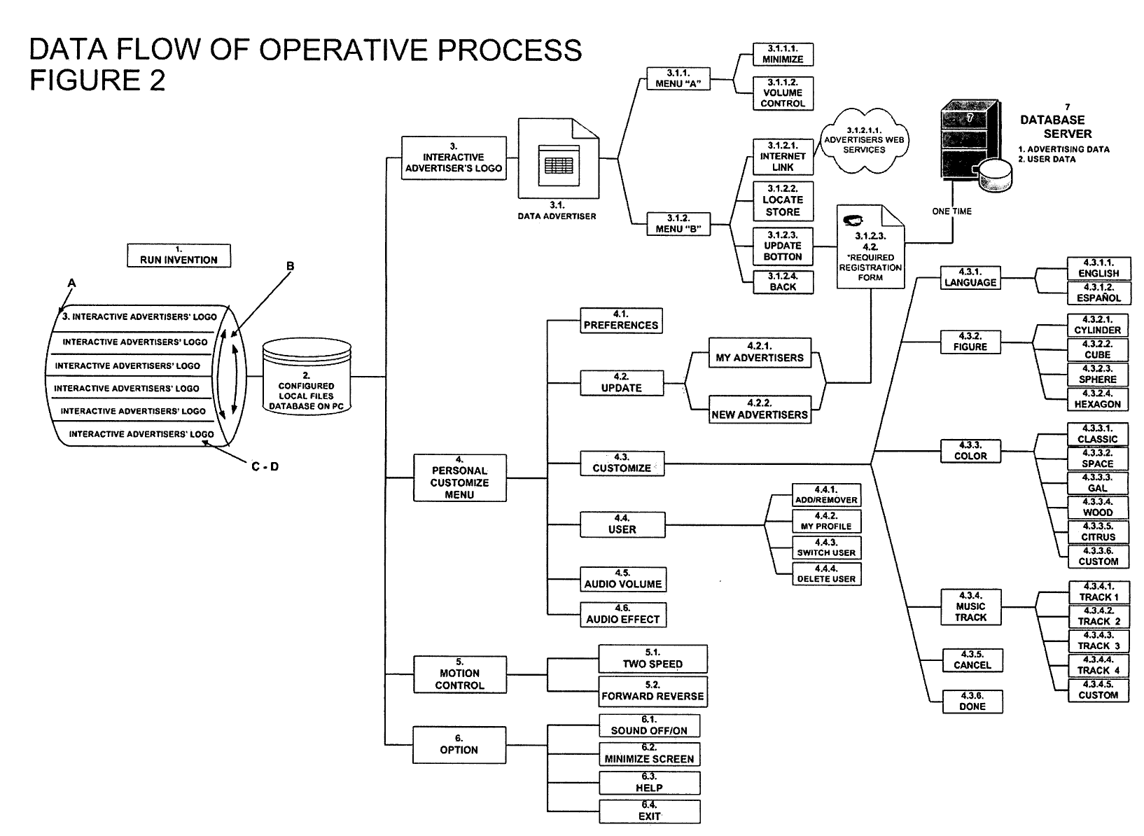

Referring to FIG. 2, after installation, users have the option to modify the software settings by selecting Customize 4.3. Customize 4.3 permits the user/consumer to modify the language 4.3.1, color 4.3.3, and music track 4.3.4 preferences that are stored in the initial software settings. In the preferred embodiment, multiple language selections are available. Language selection will change the navigation text on screen and will also change the advertiser's language where the advertiser has provided advertising information in the selected language.

Theme selection allows the user/consumer to select the color/background 4.3.3 for each navigation screen in the system including the figure. Sample theme selections are Classic 4.3.3.1, Gal 4.3.3.3, Space 4.3.3.2 and Wood 4.3.3.4. However, where advertisers have provided their own color/background preferences these will override those selected by the user.

Music Tracks 4.3.4 provide user selectable soundtracks to accompany navigation and advertising data screens; however, where advertisers have supplied their own sounds these will override user selection when users select an advertiser. Both the advertiser's logo on the figure and the associated accompanying data screens can be accompanied by the advertiser's sounds or music.

Users may select the advertisers they are interested in by using the Interactive Advertiser's Logos 3 which allows the user to select advertisers or product categories that interest him. When the consumer selects to Customize 4 the software, displays screens list categories of advertisers and/or products that are available. In the preferred embodiment, the first display screen provides users with product categories that they choose to have marketed to them. Upon selection of a product category, users are shown a submenu or display screen that allows users to select those members of the category that the user prefers to receive information from. Users can select any or all of the categories and members of each selected category. This preference data is stored locally in the consumer preferences FIG. 1-4.3 and 2 and subsequently, as will be later described, in the Database Server 7.

After installation the software displays the figure with the logos of all the participating advertisers. At any time when the user is viewing the figure, he can select the Menu button 4 which takes the user to several options. Upon selecting Menu the user may: Customize preferences 4.1, Update 4.2, Customize FIG. 4.3 or Modify User Profile 4.4.

There are two types of Updates available to the user/consumer: a global update for all preferred (selected under Preferences 4.1) advertisers 4.2.2, categories, and products; and an advertiser specific Update 4.2.1. The global update is performed by first selecting Menu 4 from the initial screen, then selecting Update 4.2 from the subsequent figure screen.

Before a user/consumer performs an update for the first time he is required to register 4.2 his personal information in the system so that his information resides in the Database Server 7. This registration permits tracking the specific consumer's interest in advertisers and their products. It also forms the basis of CRM contact input for the advertiser. This registration process is accomplished over a network. In the preferred embodiment described here, the user/consumer enters name, address, date of birth, address, phone and email address. One skilled in the art can appreciate that additional data or less data may be collected. In addition to data entered by the user/consumer, the network address of the user/consumer, where available, is collected and recorded into the database. The registration 4.2 initiates the tracking of user/consumer interest in specific advertisers, product categories or products by the participating advertisers. Information that is tracked in this embodiment includes when a user performs an update, when a user accesses the software locally, number of visits to a site advertiser or specific promotion, and user preferences in terms of product, category, and advertiser.

Upon completing registration (required for a first update only), the user's local database FIG. 1-4.3.4 and 2 is updated from the advertiser information located in the advertiser database. Update data includes sounds, text, graphics, links, animations, videos, and data screens provided by selected advertisers.

As described above, after installation the GUI appears on the consumer's display. On the face or facets of the rotating figure are the logos 3 of various companies that wish to participate through this direct advertising system/method. Logos 3 may be text or graphical, videos, animations, and accompanied by sound, which is either supplied by the advertiser or a default sound in the software. The GUI spins at user controlled speeds and can slow, stop or reverse 5 depending on cursor movement via mouse or other input device over the GUI. These buttons 5.1, 5.2 control speed and direction of the GUI.

Upon selection of a logo, a data screen containing more information provided by the advertiser appears on the display. This data screen may contain links to subsequent data screens that include more product categories or products, links to an individual advertiser's web site 3.1.2.1 for online shopping, or the ability to locate a store by mall or consumer zip code 3.1.2.2.

The invention also provides a means for advertisers who pay an additional premium to receive demographic and preference information from the Database Server 7. This information will include, but is not be limited to, viewing time on advertisers' website, commercials viewed, advertisements selected for viewing, links followed, individual products viewed, and products purchased. The demographic and preference information will be stored in a downloadable format for all subscribing advertisers to access.

The software will also include an accounting function, which will keep track of the number of downloaded transactions of each individual advertiser's advertisements by the consumers, the size and bandwidth requirements of the individual advertisers' advertisement, the number of individual disks and downloads containing the advertisers' information which have taken place, and the frequency of appearance on the GUI that each advertiser has paid for during the contracting phase. The software will monitor any outstanding payments which are due by the participating advertisers and control viewing of advertisements accordingly.

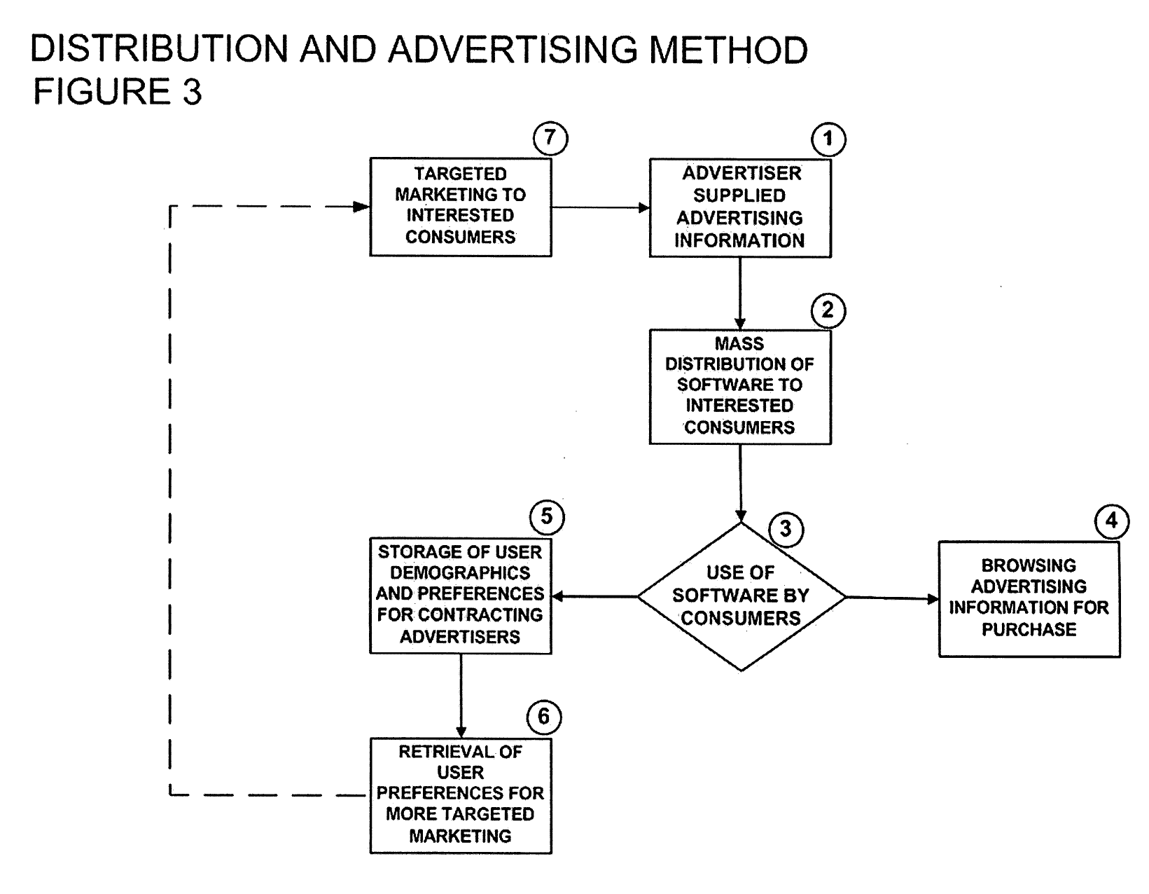

Referring to FIG. 3, the hyphenated lines found within FIG. 3 represent the potential flow of information within this method. This invention provides a business method for advertisers to target only consumers that have an interest in their products. This method allows advertisers to supply advertising information 1 that they wish to be included in a mass distribution to all interested consumers 2. Through use of the software 3, consumers will browse the provided advertising information 4 for potential on-line or in-store purchasing. The demographic and preference information of the consumers will be stored in the consumer database 5 for retrieval by advertisers 6 who have paid for this service. This demographic and preference information will allow the contracting advertisers who have paid for this service to properly customize their advertisements to their targeted consumer demographics 7.

It is intended that any other embodiments of the present invention that result from any changes in application or method of use or operation, method of manufacture, shape, size, or material which are not specified within the detailed written description or illustrations contained herein yet are considered apparent or obvious to one skilled in the art or within the scope of the present invention.

What is claimed is:

1. A method of a computer-based advertisement distribution system using selected distribution media (including, but not limited to: mass distribution disk, other digital media, or over a downloadable network) to provide a consumer GUI, comprising the steps of:
a. Contracting by advertisers for a fee to have their advertising information, such as graphics, text, links to website, advertisements, animations, video, music, and other visual media forms, such that advertisers' products may be segregated by specified criteria and included on the Database Server;
b. Distribution to the consumer of the computer-based advertisement distribution system allowing consumers to run the software from the distribution media;
c. Running the distribution media from the consumer's computer to allow viewing of the pre-configured GUI populated with the advertising information;
d. Shopping and browsing by the consumer of the local pre-populated advertising information available on the distribution media;

2. A method of a computer-based advertisement distribution system using selected distribution media (including, but not limited to: mass distribution disk, other digital media, or over a downloadable network) to provide a consumer GUI, comprising the steps of:
a. Contracting by advertisers for a fee to have their advertising information, such as graphics, text, links to website, advertisements, animations, video, music, and other visual media forms such that advertisers' products may be segregated by specified criteria, included on the Database Server;
b. Distribution to the consumer of the computer-based advertisement distribution system allowing consumers to run the software from the distribution media;
c. Running the distribution media from the consumer's computer to allow viewing of the pre-configured graphical user-interface populated with the advertising information;
d. Installation of the software onto the individual consumer's computer hard drive from the disk, other digital media, or over a downloadable network;
e. Manual selection by the consumer of the preferred language, and ability to adjust the GUI;
f. Selection by the consumer through website links provided by the software to the vendors' websites to allow consumer exposure to a wider variety of merchandise than that available through the software;
g. Selection by the consumer through an interactive locator to find the nearest selected vendor store location based on the consumer's current location to facilitate easier in-store shopping and purchasing.

3. A method of a computer-based advertisement distribution system using selected distribution media (including, but not limited to: mass distribution disk, other digital media, or over a downloadable network) to provide a consumer GUI, comprising the steps of:
a. Contracting by advertisers for a fee to have their advertising information, such as graphics, text, links to website, advertisements, animations, and other visual media forms, included on the Database Server;
b. Receipt by the consumer of the computer-based advertisement distribution system allowing consumers to run the software from the disk or other digital media or the downloadable network;
c. Installation of the software onto the individual consumer's computer hard drive from the disk, other digital media, or over a downloadable network;
d. Registration by the consumer with the Database Server providing demographic information on the consumer;
e. Manual selection by the consumer of the preferred language, and ability to customize GUI;
f. Manual selection by the consumer of any advertising information available on the Database Server for viewing;
g. Updating from the contracting advertisers to the Database Server with any new advertising information available for consumer download or upload;
h. Updating from the Database Server to the consumer's hard drive of any new advertisers and/or advertising information available for inclusion in the consumer's individual GUI;
i. Selection by the consumer using website links to vendors' websites to allow consumer exposure to a wider variety of merchandise than that available through the software;
j. Selection by the consumer through an interactive locator to find the nearest selected vendor store location based on the consumer's current location to facilitate easier in-store shopping and purchasing.

4. The method of claims 1, 2, and 3, further comprising additional charges to all advertisers who wish to be included in the pre-populated mass distribution disk, digital media, and/or downloadable network versions and the website of the software, as opposed to those advertisers who only wish their advertisements to be uploaded by registered users.

5. The method of claims 1, 2, and 3, further comprising a GUI displayed as a spinning display wheel.

6. The method of claim 5, further comprising a spinning GUI displayed as a cylinder, cube, sphere, or hexagon with facets displaying advertisers' logos.

7. A method of providing contracting advertisers with the preferences of consumers registered in a downloadable format, comprising the steps of:
a. Registration by the advertisers with the Database Server for a fee to receive demographic and preference information of all registered users of this software, including but not limited to, viewing time on advertisers' websites, commercials viewed, advertisements selected for viewing, links followed, individual products viewed, and products purchased;
b. Storage of individual consumer preference and demographic information within the Database server in a downloadable format for all contracting advertisers to access the consumer's viewing time on advertisers' websites, commercials viewed, advertisements viewed, links followed, individual products viewed, and products purchased.

8. A method of a computer-based advertisement distribution system using a mass distribution disk or other digital media or over a downloadable network to provide a consumer GUI, comprising the steps of:
a. Distribution of the computer-based advertisement distribution system to interested consumers via selected marketing techniques, including but not limited to distribution by mail, downloadable network, and/or in-store giveaways;
b. Use of the software by consumers to browse advertising information for potential on-line and in-store purchasing;
c. Collection by the Database Server of user demographic information from consumer registration and consumer preference information, including but not limited to, viewing time on advertisers' websites, commercials viewed, advertisements selected for viewing, links followed, individual products viewed, and products purchased;
d. Storage of demographic and user preference information on the Database Server in a downloadable format to subscribing advertisers to facilitate more efficient vendor marketing strategies.

9. A method of computer-based accounting for each individual contracting advertiser, comprising the steps of:
a. Tracking the number of mass distribution disks and/or network downloads of advertisements containing the individual advertisers' information;
b. Tracking the number of downloaded transactions of the advertisers' individual advertisement by users of the computer-based advertisement system;
c. Tracking size and bandwidth requirements of the individual advertisers' advertisement;
d. Charging contracting advertisers based on their selection of the frequency which their advertisement will appear on the populated GUI, and all other information tracked for charging purposes;
e. Preventing viewing of the advertising information of those advertisers whose payments are in arrears for the computer-based advertising service.
